(19) United States
(12) Patent Application Publication
(10) Pub. No.: US 2025/0190468 A1
(43) Pub. Date: Jun. 12, 2025

(54) ENHANCED ELECTRONIC FILE MANAGEMENT AND VECTOR DATABASE SYSTEMS INCORPORATING SEMANTIC VECTORS

(71) Applicant: Consilio, LLC, Washington, DC (US)

(72) Inventors: Peter Feinberg, Castle Rock, CO (US); Rajkumar Chandrasekar, Fairview, TX (US)

(73) Assignee: Consilio, LLC, Washington, DC (US)

(21) Appl. No.: 18/967,892

(22) Filed: Dec. 4, 2024

Related U.S. Application Data
(60) Provisional application No. 63/606,854, filed on Dec. 6, 2023.

(51) Int. Cl. G06F 16/334; G06F 16/338; G06F 16/34

(52) U.S. Cl. CPC G06F 16/3344; G06F 16/3347; G06F 16/338; G06F 16/345

(57) ABSTRACT

Systems and methods receive a selection of and filter documents for an electronic document search. A semantic vector analysis module is applied to text of the filtered documents to build respective floating point vectors for each of the documents, and the respective floating point vectors are stored to a vector database. A textual query is received and vectorized to produce a query vector representing search criteria. The vector database is searched in accordance with the query vector to identify similar documents that satisfy a similarity measure. A ranked list of vectors that include highest similarity scores relative the query vector is generated and similar documents are identified. A neural network is used to process document data of the similar documents to generate a textual response to the textual query, and control signal(s) are transmitted to a user device to initiate displaying the generated textual response and question answer events.

### CROSS-REFERENCE TO RELATED APPLICATIONS

The present application claims priority to and benefit of U.S. Provisional Patent Application No. 63/606,854 filed Dec. 6, 2023, entitled ENHANCED ELECTRONIC FILE MANAGEMENT AND VECTOR DATABASE SYSTEMS INCORPORATING SEMANTIC VECTORS, the entire contents of which are hereby expressly incorporated by reference.

### FIELD OF THE INVENTION

This invention relates generally to the field of electronic file management systems, and more particularly embodiments of the invention relate to electronic file management systems incorporating semantic vectors.

### BACKGROUND

The electronic discovery process involves the identification and collection of data in a way that allows attorneys to decide whether the data is relevant and non-privileged. Often, complying with disclosure requirements is challenging due to the large volume of data that must be reviewed for relevance and privilege. In addition, data may be formatted in a wide range of formats that are not easily reviewed including emails, documents, spreadsheets, audio and video files, social media posts, and instant messages. Further, the electronic discovery process is generally subject to court-ordered deadlines and discovery cut-off dates that make it difficult to adequately satisfy legal requirements within the allotted time. Thus, a need exists for enhanced electronic file management systems.

### SUMMARY

Shortcomings of the prior art are overcome, and additional advantages are provided, through the provision of an electronic file management system incorporating semantic vectors. The system includes at least one processor, a communication interface communicatively coupled to the at least one processor, and a memory device storing executable code. When the executable code is executed, it causes the at least one processor to, at least in part, receive, via a user device of a user, an indication for selection of a subset of documents from a corpus of documents, the subset of documents is to be included in an electronic document search. The subset of documents is filtered according to predefined filter rules, resulting in filtered documents. A semantic vector analysis module is applied to text of the filtered documents to build respective floating point vectors for each document of the filtered documents, and the respective floating point vectors are stored to a vector database configured for one or more vectorized queries to be performed thereon, where the vector database is specific to the filtered documents of the electronic document search. A textual query is received, via the user device, and based thereon vectorize the textual query to produce a query vector that represents search criteria. The vector database is searched in accordance with the search criteria of the query vector to identify similar documents from the subset of documents that satisfy a similarity measure, the searching comparing similarities of the query vector to the respective floating-point vectors. A ranked list of vectors comprising highest similarity scores relative to the query vector is generated, where the ranked list identifies the similar documents. Document data of the similar documents is processed, via a neural network, to generate a textual response to the textual query, where the textual response incorporates language derived from the subset of documents, and the neural network is tuned in accordance with one or more defined rules. One or more control signals are transmitted to the user device to initiate displaying, via the user device, the generated textual response and a history of question answer events, where the history includes the textual query and the textual response.

Additionally, disclosed herein is a computing environment that includes at least one processor, a communication interface communicatively coupled to the at least one processor, and a memory device storing executable code that, when executed, causes the at least one processor to, at least in part, receive, via a user device of a user, one or more textual inputs indicating whether one or more documents identified in response to a document query is responsive to the document query. Further, a selection of a subset of documents from a corpus of documents is received, via a user device of a user, the subset of documents to be analyzed in response to the one or more textual inputs. The subset of documents is iteratively processed, via a neural network, to determine a rationale for why each respective document of the subset of documents received a specific relevance score in response to the document query, where the neural network is tuned in accordance with one or more defined rules. A textual response of the determined rationale is generated, where the textual response includes a justification for the specific relevance score, and the textual response is stored to a relational database.

Also disclosed herein is a computer-implemented method that includes, at least in part, receiving, via a user device of a user, an indication for selection of a subset of documents from a corpus of documents, the subset of documents to be included in an electronic document search. The method also includes filtering the subset of documents according to predefined filter rules resulting in filtered documents and applying a semantic vector analysis module to text of the filtered documents to build respective floating-point vectors for each document of the filtered documents. The respective floating-point vectors are stored to a vector database that is configured for one or more vectorized queries to be performed thereon, where the vector database is specific to the filtered documents of the electronic document search. A textual query is received, via the user device, and based thereon the method includes vectorizing the textual query to produce a query vector that represents search criteria. Further, the method includes searching, in accordance with the search criteria of the query vector, the vector database to identify similar documents from the subset of documents that satisfy a similarity measure, the searching comparing similarities of the query vector to the respective floating point vectors and generate a ranked list of vectors comprising highest similarity scores relative to the query vector, the ranked list identifying the similar documents. Document data of the similar documents is processed, via a neural network, to generate a textual response to the textual query, where the textual response incorporates language derived from the subset of documents, and where the neural network is tuned in accordance with one or more defined rules.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

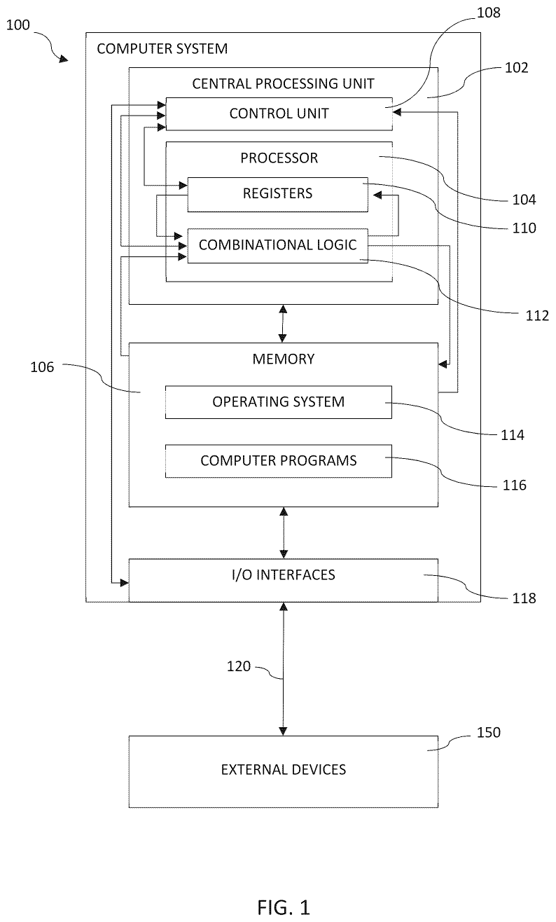

FIG. 1 depicts an example computer system configured to perform various processes described herein, according to an embodiment of the present invention;

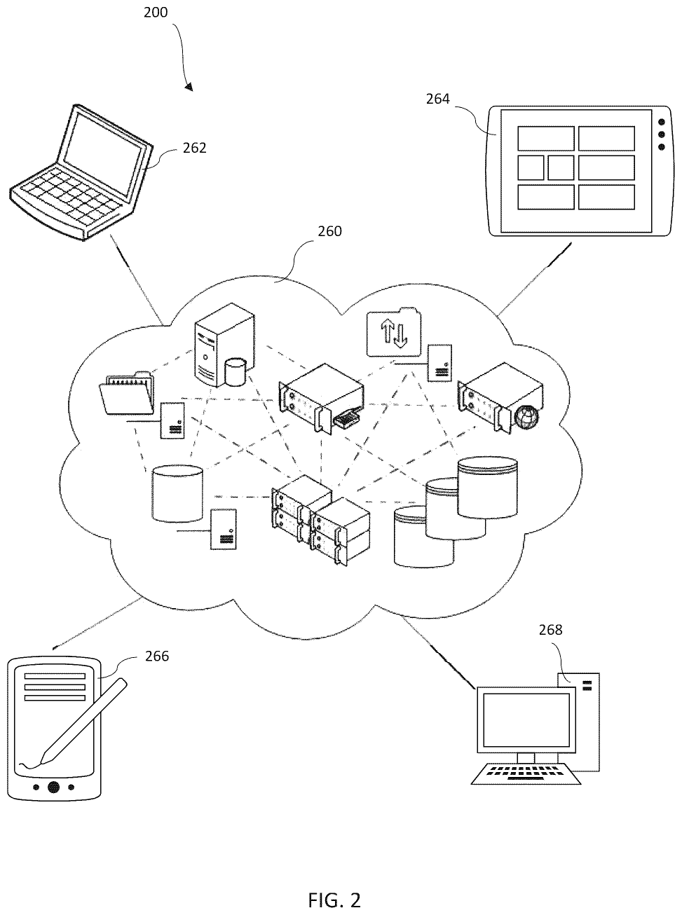

FIG. 2 depicts an example cloud computing environment, according to an embodiment of the present invention;

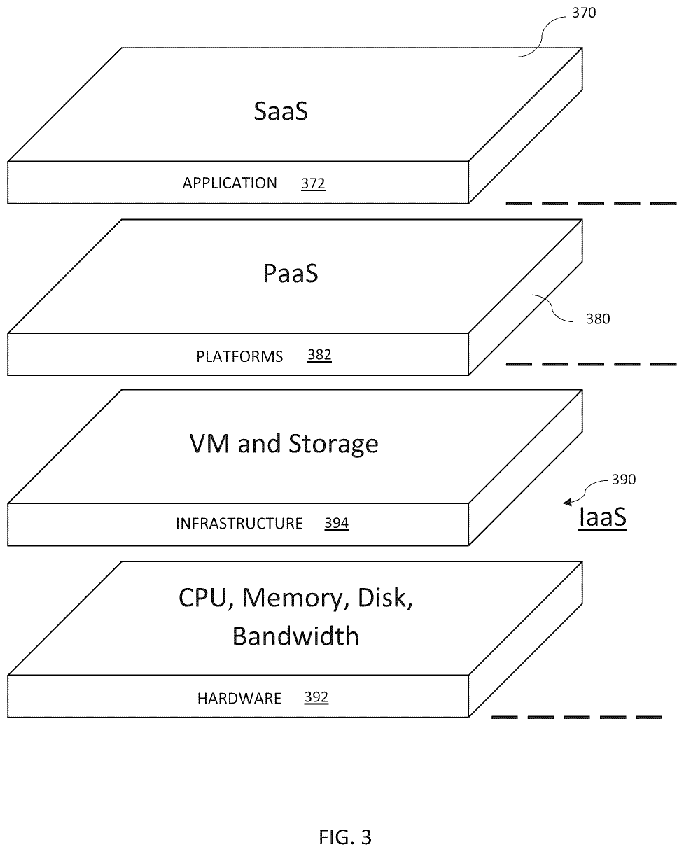

FIG. 3 depicts an example of cloud computing layers, according to an embodiment of the present invention;

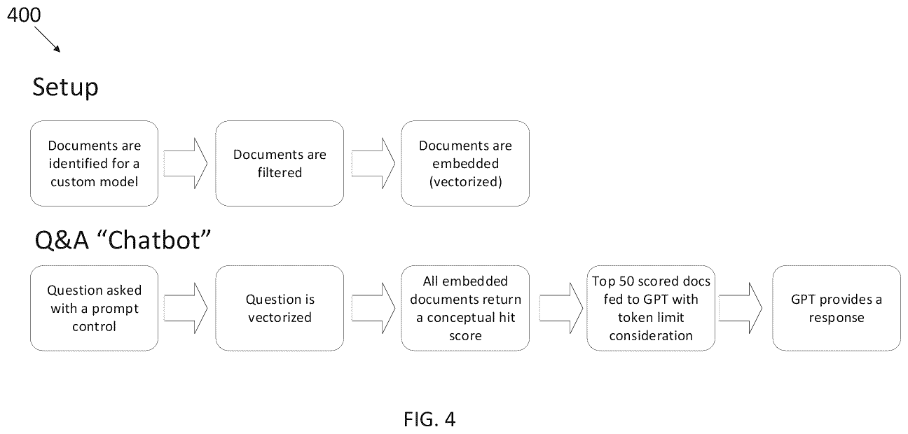

FIG. 4 is a block diagram illustrating an exemplary implementation of electronic file management, in accordance with an embodiment of the present invention;

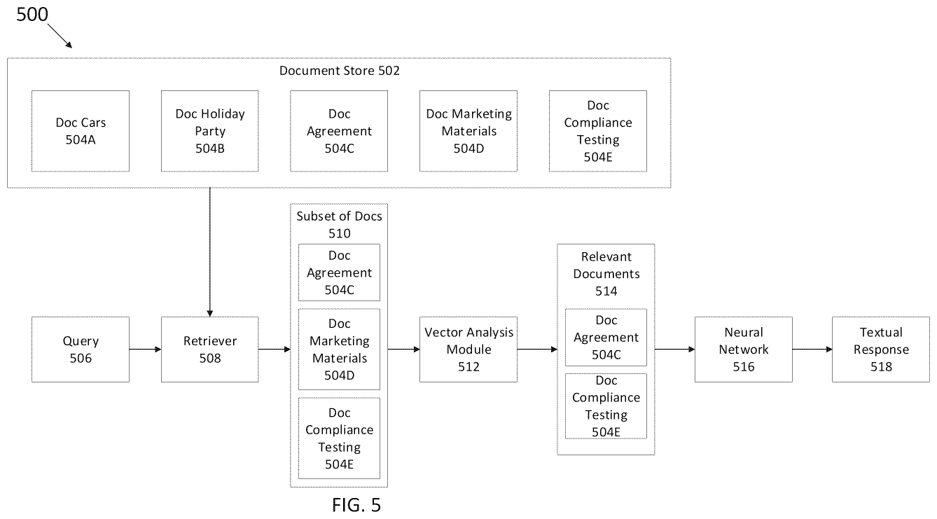

FIG. 5 is a block diagram illustrating an exemplary implementation of electronic file management incorporating semantic vectors, in accordance with an embodiment of the present invention;

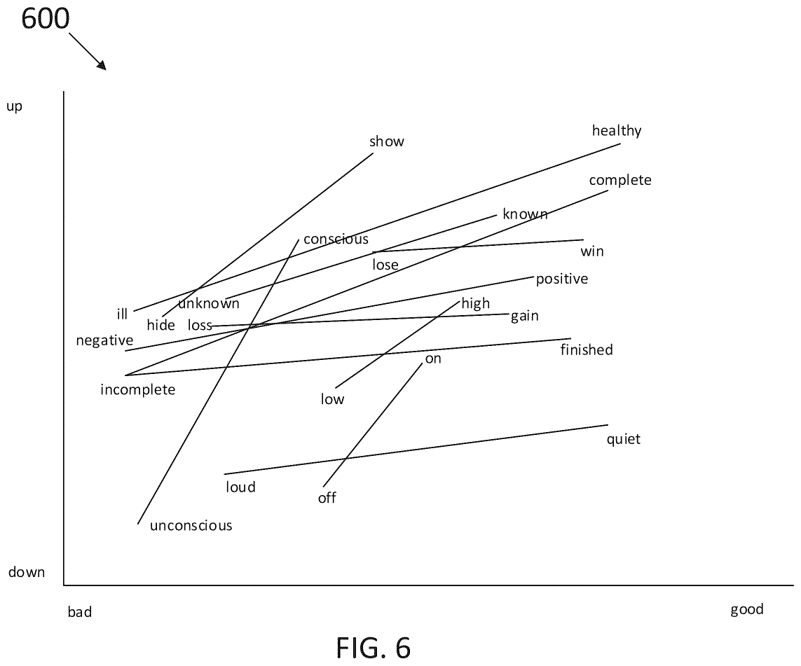

FIG. 6 depicts an example semantic space generated using an implementation of the electronic file management system, in accordance with an embodiment of the present invention;

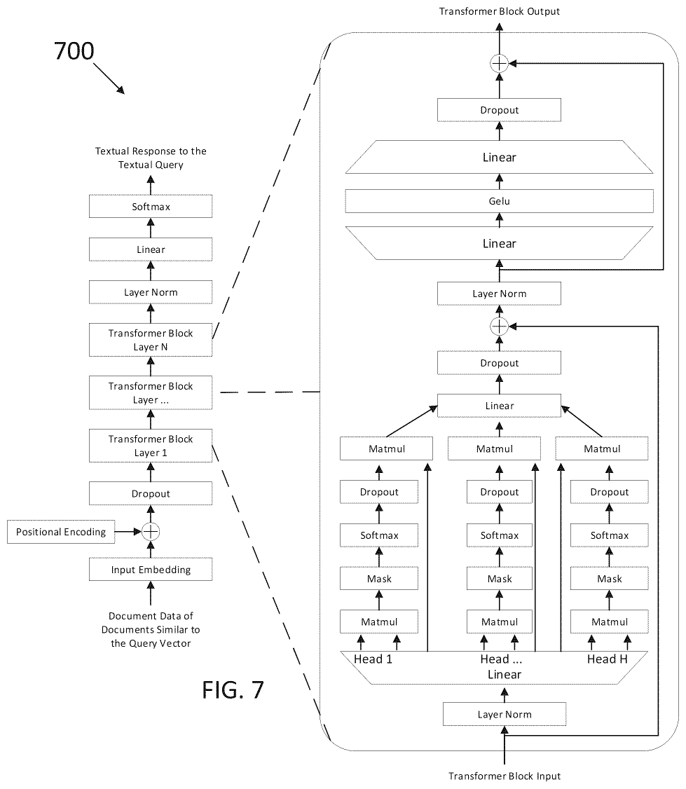

FIG. 7 depicts an example implementation of a decoder-only transformer model used by an implementation of the electronic file management system, in accordance with an embodiment of the present invention;

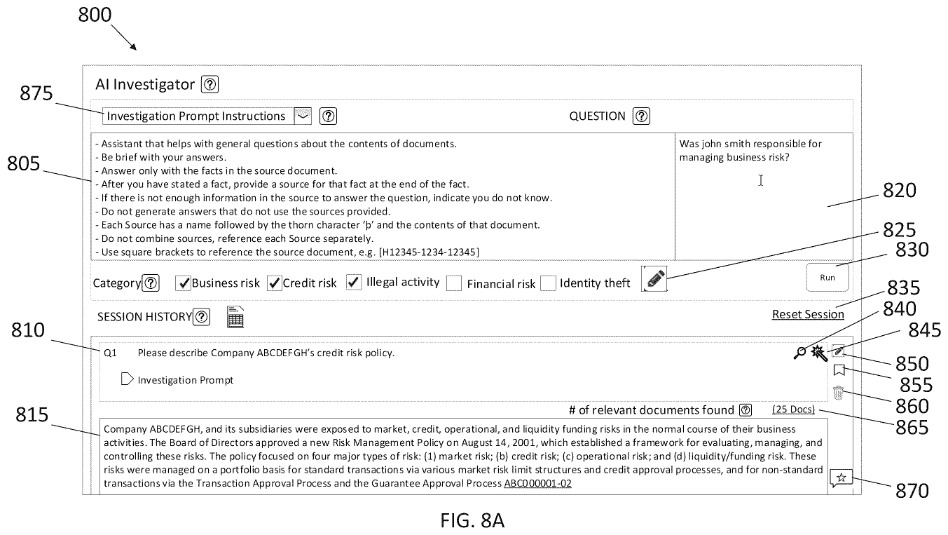

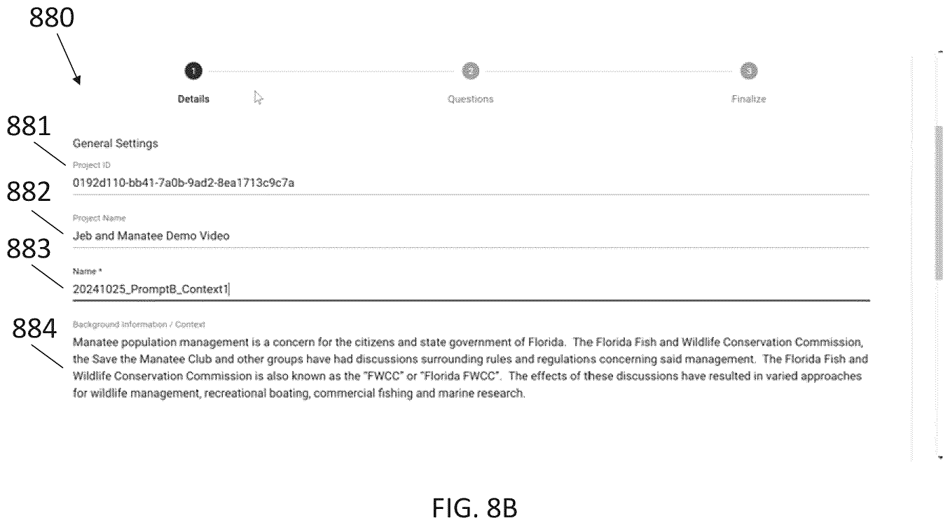

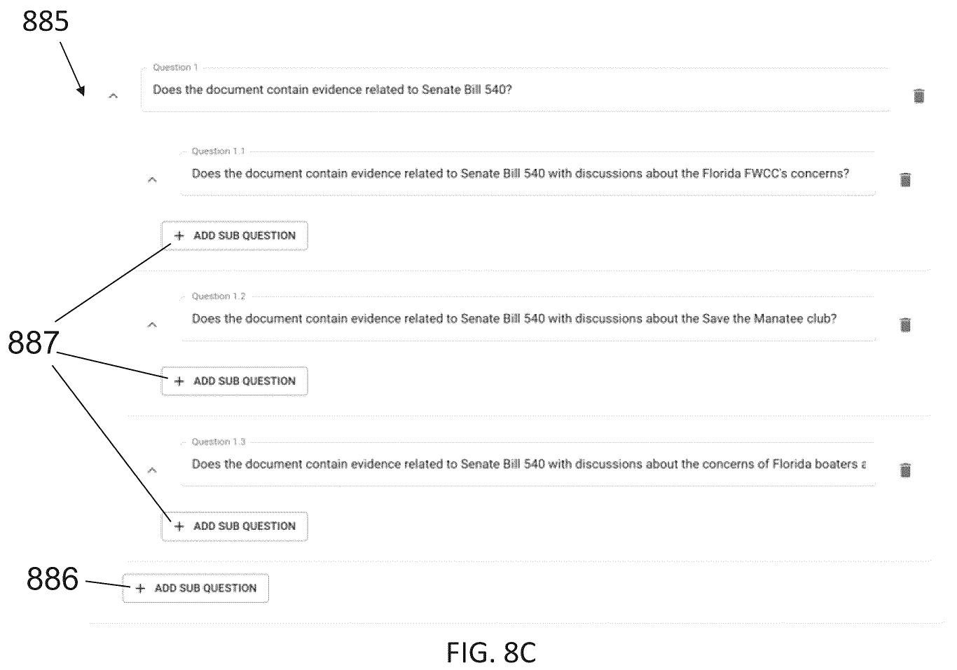

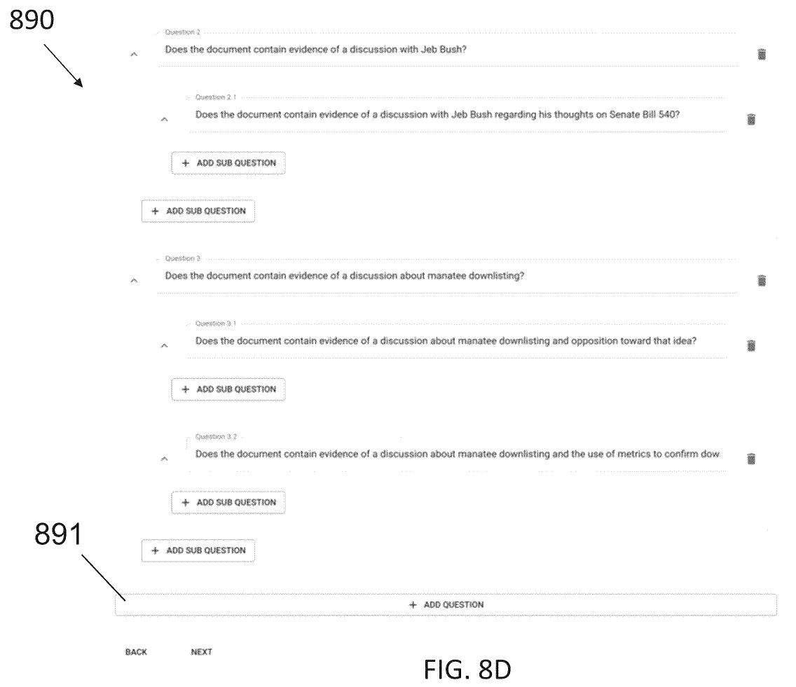

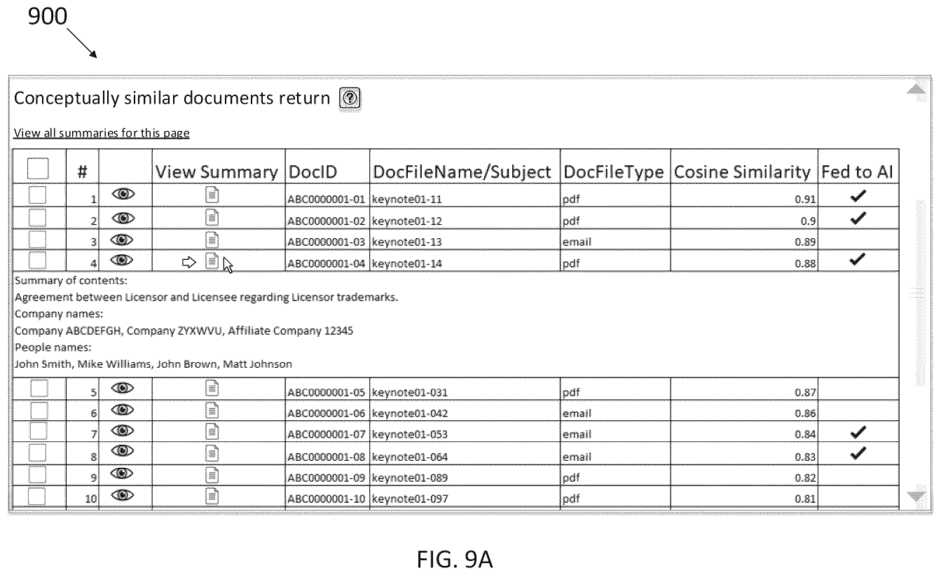

FIG. 8A depicts an example graphical user interface that includes interactive elements used to operate an implementation of the electronic file management system, in accordance with an embodiment of the present invention;

FIG. 8B depicts an example graphical user interface that includes a prompt field for capturing relevant background material or case context, in accordance with an embodiment of the present invention;

FIG. 8C depicts an example graphical user interface that includes logical sequencing inputs, in accordance with an embodiment of the present invention;

FIG. 8D depicts an example graphical user interface that includes additional logical sequencing inputs, in accordance with an embodiment of the present invention;

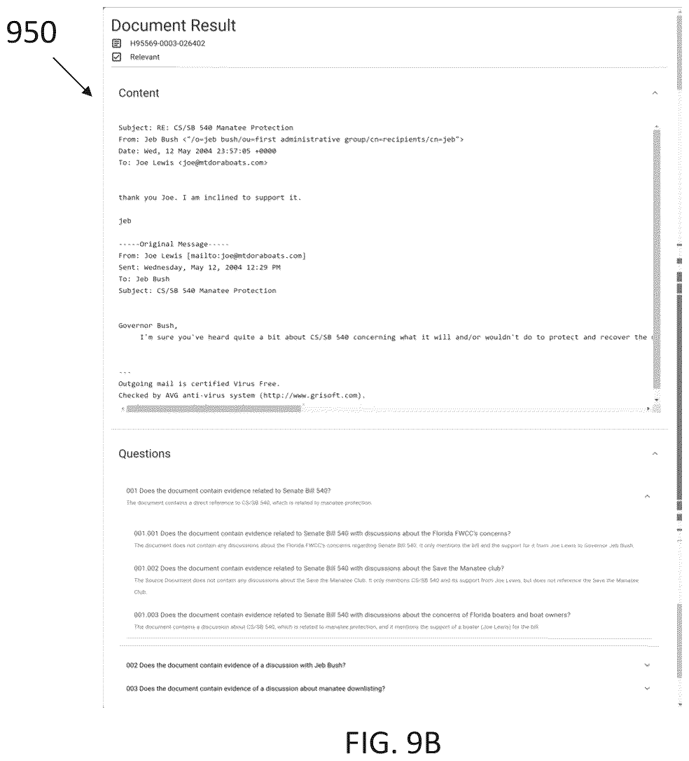

FIG. 9A depicts an example graphical user interface that includes elements of an implementation of the electronic file management system, in accordance with an embodiment of the present invention;

FIG. 9B depicts an example graphical user interface that depicts an example document relevance output, in accordance with an embodiment of the present invention;

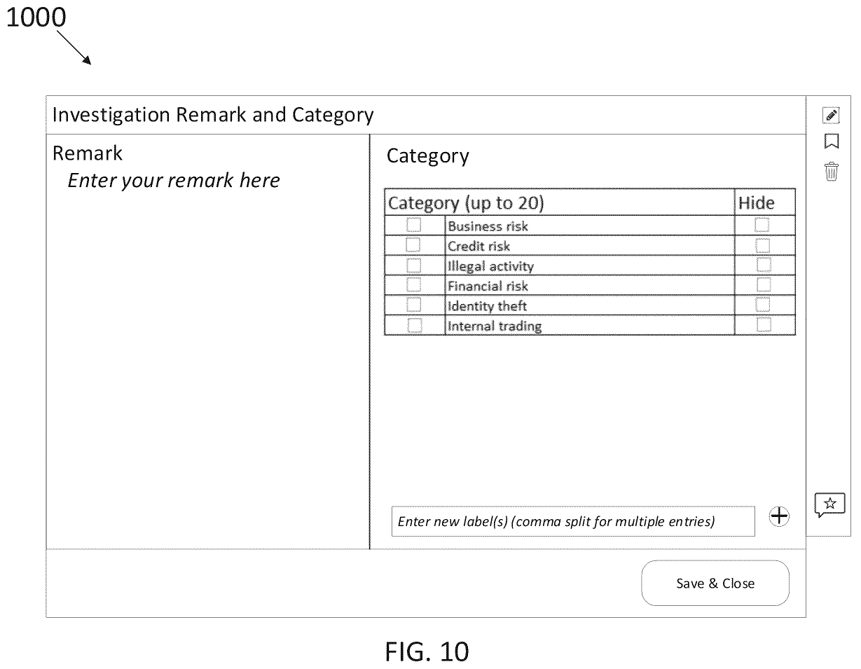

FIG. 10 depicts an example graphical user interface for categorizing documents using an implementation of the electronic file management system, in accordance with an embodiment of the present invention;

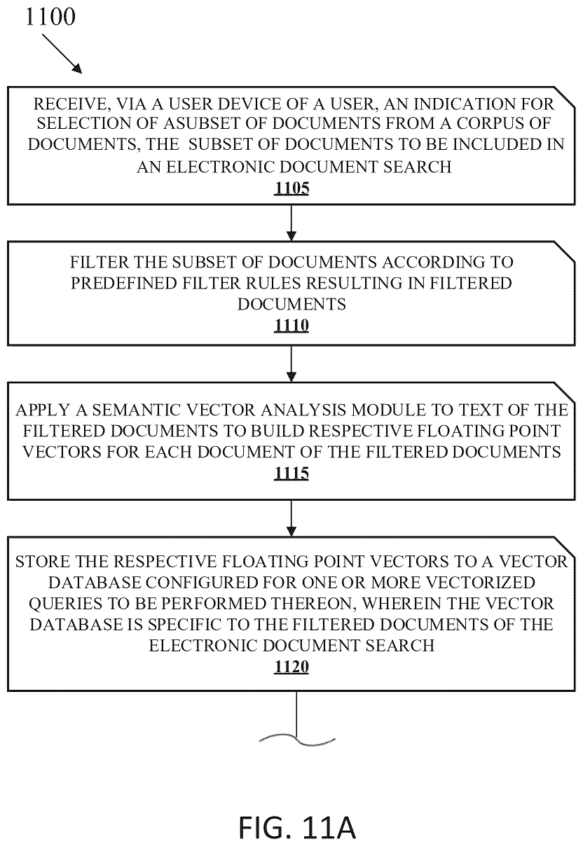

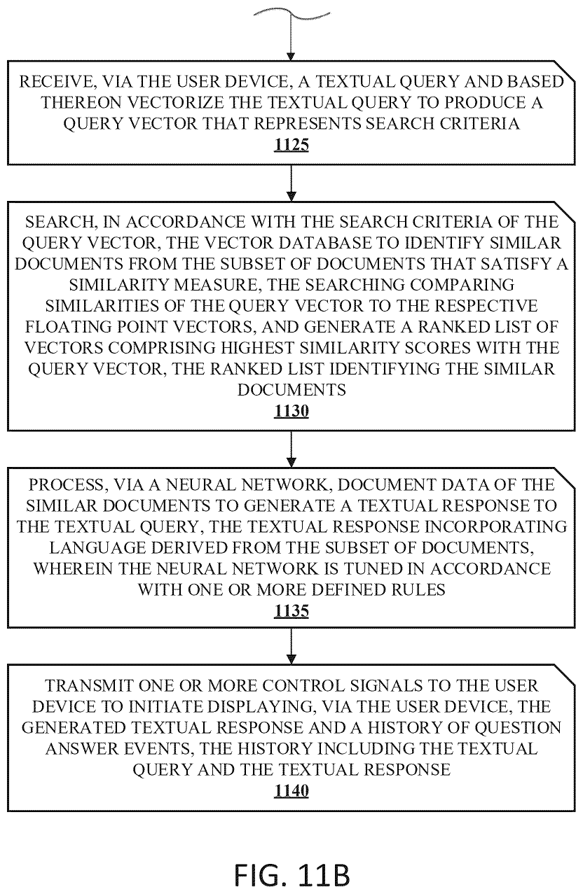

FIG. 11A is a block diagram of an example method used by an implementation of the electronic file management system incorporating semantic vectors, in accordance with an embodiment of the present invention;

FIG. 11B is a block diagram depicting additional elements of the example method of FIG. 11A, in accordance with an embodiment of the present invention; and

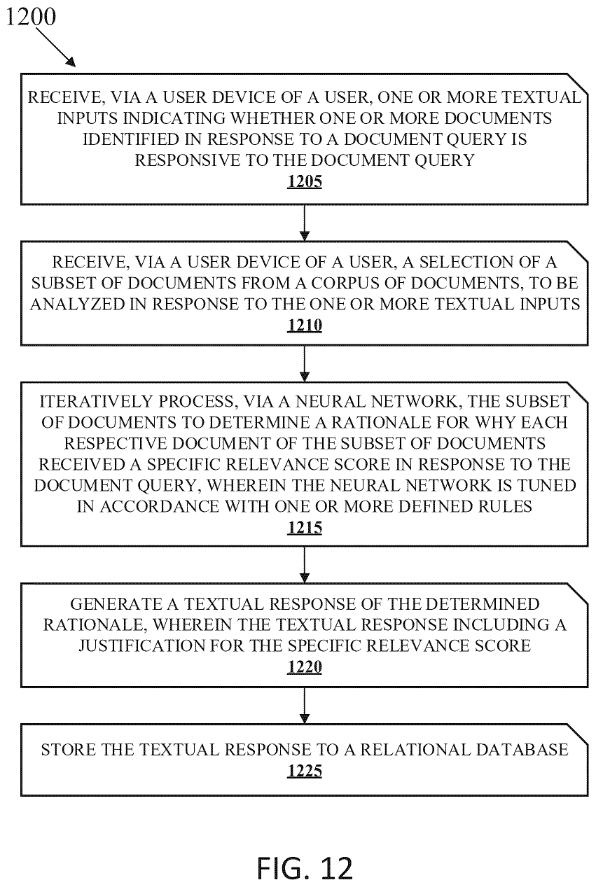

FIG. 12 is a block diagram of an example method used by an implementation of the electronic file management system, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to avoid obscuring the invention with well-known details. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprise,” “comprises,” and/or “comprising”, when used in this specification, specify the presence of stated features, integers, steps, operations, elements, and/or components, but do not preclude the presence or addition of one or more other features, integers, steps, operations, elements, components and/or groups thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises”, “has”, “includes” or “contains” one or more features possesses those one or more features but is not limited to possessing only those one or more features. Furthermore, a device or structure that is configured in a certain way is configured in at least that way but may also be configured in ways that are not listed.

The terms “couple,” “coupled,” “couples,” “coupling,” “fixed,” “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete and will fully convey the scope of the invention and enable one of ordinary skill in the art to make, use, and practice the invention. While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

### Computer Readable Instructions and Methods

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the term “provider” generally describes a person or business enterprise that hosts, maintains, otherwise provides, and/or uses computer systems that provide functionality for the disclosed systems and methods. In particular, the term “provider” may generally describe a person or business enterprise providing goods or services accessible via one or more user devices. Interactions between a provider system and a user device may utilize a communicative interaction between a computing system of the provider, and a user device of a user. For instance, user(s) may provide various inputs to a user device that can be interpreted and analyzed using processing systems of the user device and/or processing systems of the provider system. Further, the provider system and the user device may be in communication via a network. According to various embodiments, the provider system and/or user device(s) may also be in communication with external or third party devices (e.g., a third-party server) of a third-party system that may be used to perform one or more computing operations. In some embodiments, the functions of one illustrated system or server may be provided by multiple systems, servers, or computing devices, including those physically located at a central computer processing facility and/or those physically located at remote locations.

Embodiments of the present invention are described herein, with reference to flowchart illustrations and/or block diagrams of computer-implemented methods and computing systems according to embodiments of the invention. Each block of the flowchart illustrations and/or block diagrams, and combinations of blocks in the flowchart illustrations and/or block diagrams, can be implemented by computer readable program instructions that may be provided to a processor of a general purpose computer, special purpose computer, or other programmable data processing apparatus or apparatuses (the term “apparatus” includes systems and computer program products). In particular, the computer readable program instructions, which be executed via the processor of the computer or other programmable data processing apparatus, create a means for implementing the functions/acts specified in the flowchart and/or block diagram block or blocks.

In one embodiment, these computer readable program instructions may also be stored in one or more computer-readable storage media that can direct a computer or other programmable data processing apparatus, and/or other devices, to function in a particular manger, such that a computer readable storage medium of the one or more computer-readable storage media having instructions stored therein comprises an article of manufacture including instructions which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block or blocks. Example computer readable storage media may include, but not be limited to, any electronic storage device, a magnetic storage device, an optical storage device, an electromagnetic storage device, a semiconductor storage device, or any suitable combination of the foregoing. A non-exhaustive list of example computer readable storage media include a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a microdrive, a mechanically encoded device such as punch-cards or raised structures in a groove having instructions recorded thereon, and any suitable combination of the foregoing. Computer readable storage media, as used herein, may be used for long-term, intermediate-term, and/or short-term storage of computer-readable instructions, but is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In another embodiment, these computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

Example computer program instructions may include assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language (e.g., Java, Ruby, Python, C#, hypertext preprocessor (PHP), C++, or the like, and procedural programming languages, such as FORTRAN, BASIC, the “C” programming language, or similar programming languages.

The computer program instructions, whether stored in the computer-readable storage medium and/or computer-readable memory may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

In the flowchart illustrations and/or block diagrams disclosed herein, each block in the flowchart/diagrams may represent a module, segment, a specific instruction/function or portion of instructions/functions and incorporates one or more executable instructions for implementing the specified logical function(s). Additionally, the alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, or the functions of the blocks may sometimes be executed in the reverse order, depending upon the functionality involved.

### System Description

FIG. 1 depicts an example computer system 100 configured to perform various processes described herein, according to an embodiment of the present invention. The example computer system 100 may be incorporated into a user device that includes, for example, a laptop, a computer, a tablet, a mobile computing device such as a smart phone, a portable digital assistant, a pager, a television, a gaming device, an audio/video player, a virtual assistant device, an internet-of-things device, a smart home device, a wireless personal response device, any combination of the aforementioned, and/or any other electronic device with processing and communication capabilities. As used herein, a user can be an individual, a group, or an entity having access to the computer system 100. For instance, the term user may be one of many users, a market or community of users, customers, consumers, business entities, government entities, and groups of any size. The computer system 100 is in communication with one or more external device(s) 150, which may include, for example, devices (e.g., server(s)) of a provider system. The computer system 100 includes one or more central processing unit(s) 102 (CPU) that includes one or more processor(s) 104. The CPU(s) 102 and/or additional processor(s) 104 include functional components used in the execution of instructions and/or otherwise may be configured to perform a computer-implemented method by executing instructions. For example, the CPU(s) 102 and/or additional processor(s) 104 may include functional components to fetch program instructions from one or more locations such as the memory 106, which may include a cache or main memory. The CPU(s) 102 and/or additional processor(s) 104 may decode the program instructions and execute the program instructions, which may or may not require accessing the memory 106 as part of the instruction execution. Further, the CPU(s) 102 and/or additional processor(s) 104 may write results of the executed instructions to, for example, a destination register for storing the result of the execution, or various other locations for further processing and/or storage. The CPU 102 may include a control unit 108 that directs the operation of the processor(s) 104 and may include, for example, a binary decoder to convert coded instructions into timing and control signals that direct the operation of various other components (e.g., memory 106) of the computer system 100.

Processor(s) 104 may include circuitry for implementing communication and/or logic functions of the computer system 100. The processor(s) 104 may include a digital signal processor, a microprocessor, a graphics processing unit (GPU), a microcontroller, an application-specific integrated circuit (ASIC), a programmable logic device (PLD), digital signal processor (DSP), a field programmable gate array (FPGA), programmable logic arrays (PLA) a state machine, a controller, gated or transistor logic, discrete physical hardware components, various analog to digital converters, digital to analog converters, and/or other support circuits and/or combinations thereof. According to various embodiments, the processor(s) 104 may also include register(s) 110 that configured as a small amount of fast storage and may be used and/or otherwise accessed by one or more of the functional components for various operations (e.g., arithmetic operations, bitwise operations, etc.). The processor(s) 104 may also utilize a combinational logic system 112 to perform various calculations (e.g., using Boolean algebra) on input signals and stored data to produce specified outputs from such inputs. Control and signal processing functions of the computer system 100 are allocated between these processor(s) 104 according to their respective capabilities based on the functionality used to encode and interleave messages and data prior to modulation and transmission thereof. Processor(s) 104 may include an internal data modem and other functionality to operate software programs (e.g., computer programs 116). In one non-limiting example, the processor(s) 104 may be capable of operating a connectivity program, such as a web browser application, that may then allow the computer system 100 to transmit and receive (e.g., to one or more external device(s) 150) content such as, for example, web content, location-based content, etc. in accordance with a Wireless Application Protocol (WAP), Hypertext Transfer Protocol (HTTP), and/or the like.

The memory 106 may be operatively coupled to the processor(s) 104 and can be or include main or system memory (e.g. RAM), non-volatile memory, volatile memory, or any computer readable storage media used to store data, code or other information that the processor(s) 104 use in the execution of program instructions. Memory 106 can include storage device(s) such as hard drive(s), flash media, optical media, and/or cache memory that may be embedded and/or removable, as examples. Memory 106 can include, for instance, a cache, such as a shared cache, which may be coupled to local caches (examples include L1 cache, L2 cache, etc.) of processor(s) 104. In various embodiments, the memory 106 includes any tangible device that can retain and store instructions for use ban an instruction execution device (e.g., processor(s) 104). The memory 106 can store any number of pieces of information and data used by the computer system 100 to implement functions described herein as well as other functions not expressly described.

Additionally, memory 106 may be or include at least one computer program product having a set (e.g., at least one) of program modules, instructions, code or the like that is/are configured to carry out functions of embodiments described herein when executed by the processor(s) 104. Memory 106 can store an operating system 114, other computer programs 116, such as one or more computer programs/applications that execute to perform aspects described herein, and/or various other data items. Specifically, programs/applications can include computer readable program instructions and code that may be configured to carry out functions of embodiments of aspects described herein, and can also include cashed data, user files, audio files, video recordings, files downloaded or received from other devices, and/or other data items required or related to any or all of the programs/applications. Example programs/applications can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Programs/applications can also include applications (e.g., a mobile application) considered web-browser applications that typically provide a graphical user interface (GUI) that can be displayed (e.g., via a user interface) and may include features for accepting inputs from users (e.g., via control puts such as text boxes, data fields, hyperlinks, pull down menus, check boxes, and the like). Example GUI display screens are depicted in the attached figures. The GUI display screens may include features for displaying information and accepting inputs from users, and may include control inputs such as text boxes, data fields, hyperlinks, pull-down menus, check boxes, radio buttons, and the like. One of ordinary skill in the art will appreciate that the exemplary functions and user-interface display screens shown in the attached figures are not intended to be limiting, and an integrated software application may include other display screens and functions.

Computer system 100 may also include input/output (I/O) interfaces 118 through which external device(s) 150 are connected. Example external device(s) 150 in some examples may include an external sever, workstation, set of servers, cloud-based application or system, etc. located outside of the user computer system 100 that the computer system 100 may access via the Internet. In some examples, external device(s) 150 may additionally or alternatively include electrical components included within the user device itself. Specifically, an I/O device may be incorporated into the computer system 100 itself or the I/O device may be regarded as an external device 150 coupled to the computer system 100 through one or more I/O interfaces 118.

External device(s) 150 can include, but are not limited to, printers, display monitors, microphone(s), speaker(s), Global Positioning System (GPS) devices, camera(s) (e.g., digital cameras), lights, non-transitory storage media (e.g., ROM), accelerometers, gyroscopes, magnetometers, sensor devices configured to sense light, proximity, heart rate, body and/or ambient temperature, blood pressure, and/or skin resistance, activity monitors, a keyboard, a pointing device, a joystick, a button, soft key, infrared sensor, a display screen (e.g., a liquid crystal display (LCD), light emitting diode (LED) display, or the like), a sensitive input screen (e.g., a touch screen or the like), a proximity sensor or transmitter configured to detect proximate images (e.g., a quick response QR code) or objects (e.g., a radio-frequency identification tag) using electromagnetic fields, and/or any other devices that enable a user to interact with computer system 100, any device that enables computer system 100 to communicate with one or more other computing systems or peripheral devices, one or more data storage devices, which may store one or more programs, one or more computer readable program instructions, and/or data, etc., removable/non-removable storage media, volatile/non-volatile computer system storage media, a magnetic disk drive for reading from and writing to a removable, non-volatile magnetic disk (e.g., a “floppy disk”), an optical disk drive for reading from or writing to a removable, non-volatile optical disk, such as a CD-ROM, DVD-ROM or other optical media, non-volatile magnetic media (typically called a “hard drive”), and/or any other suitable devices adapted to provide an input or output to the computer system 100 and/or commonly used with any suitable operating system on personal computers, central computing systems, phones, and/or similar devices.

I/O interfaces 118 may provide communication (e.g., two-way communication and data exchanges). Example I/O interfaces 118 may additionally or alternatively include, for example, a network interface/adapter that enables the computer system 100 to communicate with one or more networks, such as a local area network (LAN), a general wide area network (WAN), and/or a public network (e.g., the Internet), and/or provide communication with other computing devices or systems, storage devices, or the like. Specific examples of I/O interfaces 118 may also include Ethernet-based (such as Wi-Fi) interfaces, near-field communication devices, transceivers, and/or Bluetooth® adapters (BLUETOOTH is a registered trademark of Bluetooth SIG, Inc., Kirkland, Washington, U.S.A.). The I/O interfaces 118 may be configured, in some embodiments, as a means for providing user inputs via virtual buttons, selectable options, a virtual keyboard, a touch screen, a touchpad, and other indicia that, when touched, can be used by the user to control the computer system 100. The I/O interfaces 118 may include and/or be operatively connected to circuitry used to convert analog signals and/or other signals into digital data, and/or may be configured to convert digital data to another type of signal. For example, the I/O interfaces 118 may receive and convert physical contact inputs, physical movements, auditory signals, etc. to digital data. Once converted, the digital data may be provided to the processor(s) 104 for processing.

The I/O interfaces 118 may be coupled to processor(s) 104, external device(s), and each other via one or more buses, circuitry, intraconnections, and/or other connections that facilitate communication. Bus connections represent one or more of any of several types of bus structures, including a memory bus or memory controller, a peripheral bus, an accelerated graphics port, a high-speed interface, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI). The bus connections may operatively couple and/or electrically connect various components of the computer system 100 with one another directly or indirectly by way of intermediate components.

The communication between I/O interfaces 118 and external devices 150 can occur across wired and/or wireless communications link(s) 120, such as Ethernet-based wired, universal serial bus (USB) wired or wireless connections. Example wireless connections include cellular, Wi-Fi, Bluetooth®, proximity-based, near field, or other types of wireless connections. More generally, communications link(s) 120 may be any appropriate wireless and/or wired communication link(s) 120 for communicating data. In some instances, the communications link(s) may utilize various modes and/or protocols, including, as non-limiting examples, global system for mobile (GSM) voice communication, short message service (SMS), enterprise messaging service (EMS), multimedia messaging service (MMS) messaging, second-generation (2G) wireless communication protocols IS-95 such as code division multiple access (CDMA), IS-136 such as time division multiple access (TDMA), personal digital cellular (PDC), or general packet radio service (GPRS), third-generation (3G) wireless communication protocols, such as Universal Mobile Telecommunications System (UMTS), CDMA2000, wideband CDMA (WCDMA) and/or time division-synchronous CDMA (TD-SCDMA), fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like.

Specific example I/O interfaces 118 that may be used to perform the processes disclosed herein may incorporate and or otherwise be configured to capture an image (e.g., via camera(s) and/or other optical instrument(s)). The I/O interfaces 118 may include one or more lenses and one or more image sensors (e.g., a charge coupled device (CCD) sensor) configured to convert photons into an electrical signal. For example, pixels of each the image sensors may each include a photodiode (e.g., a semiconductor) that becomes electrically charged in accordance with the strength of the light that strikes the photodiode, where the electrical charge is then relayed to be converted to an electrical signal. In one embodiment, a series of pulses may be applied to the one or more image sensors to relay the accumulate charges within each photodiode in succession down a row of photodiodes to an edge of the respective image sensor. Other optical instrument functionalities are also contemplated herein.

In various embodiments, the I/O interfaces 118 may be configured to obtain and/or process various forms of authentication by obtaining authentication information from a user of a user device accessing or that otherwise incorporates the computer system 100. The authentication information may be provided, for example, to access specific information that is restricted to authorized users. In one example, a restricted web portal may require login credentials from the user in order to provide the user with access to the web portal and perform various functionalities therethrough. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally, or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems. For instance, in some cases, in order to authenticate a user, the user may be required to provide multi-factor authentication by requiring more than one authentication method.

In various embodiments, the I/O interfaces 118 may include a positioning device and/or otherwise be configured to identify a geographic location of a user device using a positioning system. For example, the I/O interfaces 118 may include a GPS transceiver, an antenna, transmitter, and/or receiver that can be used, via triangulation of cellular signals, to identify an approximate location of a user device.

In some embodiments, particular portions or steps of methods and functions described herein are performed in whole or in part by way of the CPU 102, processor(s) 104, and/or cloud-based computing devices/systems such that the computer system 100 facilitates operations that may only partially be performed locally and may incorporate communication, data transfer, and/or user inputs and outputs.

According to various embodiments, the user of the computer system 100 can be any individual, a group, entity, etc. that is in possession of or has access to a user device which may be personal or public devices used to access the computer system 100. The user can provide inputs to the computer system 100 through, for example, user-side actions including voice, text, movement, and/or graphical indicia selections.

Computer system 100 may be operational with numerous other general purpose or special purpose computing system environments or configurations. Computer system 100 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like. The computer system 100 may also be referred to herein as a data processing device/system, computing device/system/node, or simply a computer. The computer system 100 may be based on one or more of various system architectures and/or instruction set architectures.

In some embodiments, the computing system environments may be configured such that the computer system 100 can generate content data manually or obtain content data from a third-party source, such as a cloud storage service or remote database. In some embodiments, the content that can be accessed can include audio data or alphanumeric text data representing written communication. The third-party system can be integrated with the computer system 100 through an application programmable interface (API) software application that facilitates communication between software systems by mapping computer-readable commands and data formats between systems. In some embodiments, the computer system 100 accesses the third-party system using an Internet browser software application to access a web-based software interface.

FIG. 2 depicts an example cloud-computing environment 200, according to an embodiment of the present invention. The cloud-computing environment 200 may be provided by a “provider” and include a network 260 that is communicatively connected, via wireless and/or wired connections to various network devices that may be local and/or remote to one another. Example network devices may include the user devices, such as laptop 262, tablet 264, smart phone 266, and desktop 268, as well as various other computing devices, mobile devices, and/or servers. As depicted, the network 260 can be a large, distributed network that includes multiple servers (e.g., file servers, catalog servers, computing servers, application servers, etc.), databases, storage locations, and/or computers. The network 260 may facilitate sharing data and/or resources across distributed locations. Although singly depicted with one network 260 for illustrative convenience, the cloud-computing environment 200 may include more than one network without departing from the scope of this description. In some embodiments, the network 260 may be or include a secured network. In some embodiments, the network 260 may be implemented, at least in part, through one or more connections to the Internet. In some embodiments, a portion of the network 260 may include a virtual private network (VPN) or an Intranet.

The cloud-computing environment 200 may also include wired and wireless links, including, as non-limiting examples, 802.11a/b/g/n/ac, 802.20, WiMAX, LTE, and/or any other wireless link. The network 260 may include any internal or external network, networks, sub-network, and combinations of such operable to implement communications between various computing components within and beyond the illustrated cloud-computing environment 200. The network 260 may communicate, for example, Internet Protocol (IP) packets, frames using frame relay, voice, video, data, and other suitable information between network addresses. The network 260 may also include one or more local area networks (LANs), radio access networks (RANs), metropolitan area networks (MANs), wide area networks (WANs), personal area networks (PANs), WLANs, campus area network (CAN), storage-area network (SAN), all or a portion of the internet and/or any other communication system or systems at one or more locations.

The network 260 may incorporate various cloud-based deployment models including, for example, private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public that remain unique entities but are bound together by standardized or proprietary technology that enables data and application portability (e.g., load-balancing between cloud networks).

At least some of the network devices, such as the user devices (e.g., laptop 262, tablet 264, smart phone 266, and desktop 268) may include a computer system, such as the computer system 100 of FIG. 1. The network 260 may also include any number of data sources, user devices, consumers, customers, third-party devices, external databases, servers, etc. from any number of users (e.g., individual persons, institutions, companies, organizational entities, groups, etc.). In some embodiments, the network 260 incorporates any number of virtual resources, such as cloud resources or virtual machines. Virtual resources may utilize a cloud-computing configuration to provide an infrastructure that includes a network of interconnected nodes and provides stateless, low coupling, modularity and semantic interoperability. Such interconnected nodes may incorporate a computer system that includes one or more processors, a memory, and a bus that couples various system components (e.g., the memory) to the processor, and may be grouped physically or virtually in one or more networks. It should be understood that such interconnected nodes may include the types of computing devices and systems depicted, as an example, in FIG. 1, which is intended to be illustrative only, and such interconnected nodes can communicate with any type of computerized device across the network 260. Such virtual resources may be available for shared use among multiple distinct resource consumers and in certain implementations, virtual resources do not necessarily correspond to one or more specific pieces of hardware, but rather to a collection of pieces of hardware operatively coupled within a cloud-computing configuration so that the resources may be shared as needed.

Cloud computing utilized by the cloud-computing environment 200 is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Processes described herein may be performed singly or collectively by one or more computer systems (e.g., such as computer system 100) that are accessible via the network 260. It is to be understood that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

The network 260 of the cloud-computing environment 200 may be configured to be accessed by a network device (e.g., laptop 262, tablet 264, smart phone 266, and desktop 268) to provision computing capabilities, such as server time and network storage, as needed without requiring human interaction with the provider. Further, the network 260 may be accessed through standard computer systems (e.g., via I/O interfaces 118 of computer system 100) used by thin or thick client platforms (e.g., mobile phones, laptops, PDAs, etc.). Further, the network 260 may pool computing resources to serve multiple network devices using, for example, a multi-tenant model with various physical and virtual resources assigned in accordance with demand. For instance, physical and/or virtual resources accessed via the network 260 may be dynamically assigned and reassigned to different end-users such that the end-user has no control or knowledge of the exact location of the provider resources accessed via the network 260, although general abstraction may be used to identify a datacenter location, city, state, country, etc. The network 260 may also be scaled and provisioned, sometimes automatically, rapidly and elastically based on various functionality requirements and/or usages. In some instances, the network resources available via the network 260 may be regulated based on a metering capability (e.g., based on storage, processing, bandwidth, active user accounts, etc.).

FIG. 3 depicts an example of cloud computing services, according to an embodiment of the present invention. The cloud computing services may be utilized by a cloud computing environment (e.g., cloud-computing environment 200) and may include a Software-as-a-Service (SaaS) 370, a Platform as a Service (PaaS) 380, and/or an Infrastructure as a Service (IaaS) 390. The cloud computing services offer infrastructure, platforms, and/or applications/software as services to and end-user so that the end-user does not need to maintain resources on a local computing device.

The SaaS service 370 may provider an end-user with the ability to use the provider's applications that are accessible and operable via cloud infrastructure. Specifically, the provider's applications layer 372 may be accessible via various network devices that include computer systems (e.g., computer system 100) via, for example, a thin client interface such as a web browser. With the SaaS model, the end-user is not authorized to manage or control the underlying cloud infrastructure, network, servers, operating systems, storage, or individual application capabilities offered by the provider, with the exception of limited user-specific application configuration settings.

The PaaS service 380 may provide the end-user with the ability to deploy consumer-created or acquired applications onto the cloud infrastructure using a platform layer 382, where the consumer-created applications may be created using programming languages and tools supported by the provider. Specifically, the end-user is not authorized to manage or control the underlying cloud infrastructure including networks, servers, operating systems, or storage. However, the end-user is authorized to control the deployed applications and possibly application hosting environment configurations available via the platform layer 382.

The IaaS service 390 may provide the end-user with the ability to provision processing, storage, networks, and other fundamental computing resources. The IaaS service 390 includes a hardware layer 392 that is responsible for managing the physical resources available via the cloud-computing environment (e.g., cloud-computing environment 200). Specifically, the hardware layer 392 may include physical servers, routers, switches, power and cooling systems and may, according to one embodiment, be implemented using one or more data centers that incorporate many (e.g., hundreds, thousands, etc.) of interconnected servers, CPUs, mainframes, reduced instruction set computer (RISC), architecture based servers, blade servers, storage devices, network computing components, memory, disk, bandwidth, etc. organized through switches, routers, and/or other fabrics.

The IaaS service 390 may also include an infrastructure layer (e.g., a virtualization layer) 394 that includes virtual machine capabilities and storage capabilities using computing resources that may be partitioned using various virtualization technologies (e.g., a hypervisor that runs directly on the system hardware (e.g., Xen), a kernel-based virtual machine (KVM), Hyper-V virtualization, VMware software, etc.). With IaaS service 390, the end-user may be able to deploy and run arbitrary software, which can include operating systems and applications, via the virtual machines. Although the end-user would not be authorized to manage or control the underlying cloud infrastructure, the end-user would be authorized to control operating systems, storage, deployed applications, and some limited network components (e.g., host firewalls).

Although various embodiments are described above, these are only examples. For example, computing environments of other architectures can be used to incorporate and use one or more embodiments. Many variations are possible.

### Investigative User Experience: Processing Documents for Custom Model

Electronic file management systems are available through software applications to users in order to access electronic files, including audio files, video files, and written electronic communications. Electronic file management systems disclosed herein can be used to perform electronic discovery review of files in order to comply with disclosure requirements. Additionally, the electronic file management systems can be used to identify documents in order to satisfy state and federal reporting requirements (e.g., by the Federal Energy Regulatory Commission (FERC), Securities and Exchange Commission (SEC), and the Food and Drug Administration (FDA)). The systems and methods described herein advantageously provide users with an ability to submit queries and receive responses in a human-like semantic form. In particular, the disclosed systems and methods provide a convenient and user-friendly method for quickly obtaining relevant answers to queries.

Advantageously, the disclosed systems and methods enhance existing computer technology for identifying and generating specific answers to queries, where the source of the answers is limited to a predefined corpus of documents associated with a particular entity rather than open-source information. This technology has several potential uses ranging from electronic discovery to regulatory reporting. Prior methods of obtaining answers to queries were limited to generating a list of search results that fit the parameters input by the user. Often, the search results may not be sufficiently relevant due to limitations in the search functionality, or the search results may require further manual searching in order to interpret or find an answer within relevant documents.

The disclosed systems and methods also enhance subsequent review of search results over conventional systems. Conventional searching methods and techniques return a list or set of documents that must be manually reviewed for relevance or compliance with search criteria. The present systems and methods return search results that include citations and summaries of key points of the most relevant documents, which obviates the need for manual review and reading of entire documents returned without the search results.

The disclosed systems and methods implement semantic vector analysis modules to build a vector database so that vectorized queries can identify the most relevant documents and neural networks to generate a textual response from those documents identified as being the most relevant. The processes performed by the disclosed systems and methods are not practically performed in the human mind and do not recite any method of organizing human activity.

In addition, the disclosed systems and methods perform multi-threaded embedding processes for embedding requests for multiple documents from different users in order to manage large volumes of network traffic. The systems and methods also use batching and parallel threading across multiple servers and multiple locations in order to adaptively monitor and route network traffic data, which necessarily incorporates a combination of elements for collecting data and routing data in such a way that avoids excess traffic volume on the network, which hinders network performance. Traffic volume workflow data can be collected and analyzed in order to improve network workflow to handle the parallel load across servers and locations. In particular, the disclosed systems and methods may be programmed to only collect additional volume workflow data when network traffic surpasses a predefined threshold of reduced network performance so that only data that is relevant for the traffic volume workflow analysis is collected.

FIG. 4 is a block diagram illustrating an exemplary system 400 for electronic file management, in accordance with an embodiment of the present invention. Initially, the first step involves a setup process where a user of a software application selects which subset of documents of a corpus of documents should be included in a custom model. Advantageously, in the context of a law firm environment where the user is performing electronic discovery, the documents can be limited to documents for a specific client, matter, corporate division, etc.

Once the corpus of documents is selected, the system automatically filters out documents that will not satisfy certain model criteria. For instance, documents with a very limited amount of text, massive documents with hundreds or thousands of pages, spreadsheets, multimedia files, etc. may be filtered out during the setup process. The documents can be filtered out by file size, the number of alphanumeric characters in a document or other criteria.

Once the documents are filtered and streamlined or “reduced,” the documents are then embedded or vectorized such that the text, and optionally accompanying metadata (e.g., a created date, a sent date, email recipients, etc.), in the document is modelled mathematically into a floating-point vector (e.g., a 1000+ attribute floating-point vector). The embedding/vectorization process generates a vector representation for each modelled document, and the vector representations are stored to a vector database in order to facilitate a question/answer process.

According to one embodiment, documents that include spreadsheets are analyzed and embedded such that spreadsheet data are separated into rows in order to individually embed each row. The embedding process classifies header information along with the corresponding values in each row in order to maintain context so that a query to the vector database can interpret the context of the values using the header information in order to provide an answer.

In various embodiments, the embedding process is a multi-threaded operation that can feed embedding requests for multiple documents concurrently to the vector analysis module. In some embodiments, the vector analysis module includes a generative pre-trained transformer (GPT) or other neural network machine-learning model that is trained to perform the document embedding/vectorization.

According to one embodiment, a vector database is configured to store data as high-dimensional vectors that each has a number (e.g., tens to thousands) of dimensions and mathematically represent features or attributes. The vector database is queried based on semantic and/or contextual meaning rather than an exact match or predefined criteria. Querying the vector database facilitates identifying documents that are similar based on topic and sentiment.

### Investigative User Experience: Queries and Responses

Once the system is set up with a vector database, a user may submit a question using a prompt control. The question is then vectorized by the system to generate a query vector that is then applied to the vector database in order to perform a similarity comparison and obtain documents that are relevant to the concepts/facets included in the query vector. The query vector represents the desired information and criteria and is derived from textual data of the query. The similarity comparison assigns all embedded documents with a conceptual hit score, and the top-scoring documents (e.g., the 50 documents with the highest score) are analyzed using a neural network, such as a GPT engine that is trained to answer a question using only the information provided in the top-scoring documents. The GPT engine may be trained to provide a textual response in a human-like semantic form.

According to one embodiment, the vector analysis module and the neural network leverage a decoder-only transformer model in order to perform semantic document search and question and answering functions. Specifically, the disclosed systems and methods enable users to ask questions in natural language and produce answers from a filtered set of documents. Advantageously, the semantic document search obtains documents based on the meaning of the question/query rather than performing a keyword search. Further, a summary of the most relevant documents may also be generated. In some instances, the disclosed systems and methods can automate the answering process such that context can be derived from prior questions in a Chabot format.

FIG. 5 is a block diagram illustrating an exemplary system 500 for electronic file management incorporating semantic vectors, in accordance with an embodiment of the present invention. Specifically, the exemplary system 500 functions as a pipeline that analyzes documents 504A, 504B, 504C, 504D, 504E, of a document store 502 in order to produce a textual response 518. When a query 506 is received, a retriever 508 acts as a filter that reduces the number of documents from a corpus of documents stored to the document store 502. The retriever 508 scans all documents in the document store 502 and identifies a subset of documents 510 based on a prompt or selection provided by a user that is associated with the query 502. The retriever 508 obtains the subset of documents 510, which for the purposes of illustration are depicted as documents 504C, 504D, and 504E, and passes the subset of documents 510 on to the vector analysis module 512 so that the documents 504C, 504D, and 504E can be analyzed. The vector analysis module 512 may incorporate a transformer-based language model to analyze the document. The vector analysis module 512 may leverage graphics processing unit (GPU) acceleration in order to process the documents 504C, 504D, and 504E and identify the most relevant documents 514, which for illustration purposes are depicted as documents 504C and 504E. The neural network 516, which may be a GPT engine, then generates a textual response 518 using language from the relevant documents 514. Specifically, the neural network is programmed to generate the textual response 518 only using data from the relevant documents 514 and not open-source information.

FIG. 6 depicts a graph 600 of an example semantic space generated using an implementation of the electronic file management system, in accordance with an embodiment of the present invention. The semantic space may be generated from a term document matrix, which incorporates several terms and documents that may be identified using a semantic vector analysis module, such as those described herein. The semantic space is an example natural language domain that provides a representation of natural language that provides meaning to terms. Words are represented as feature vectors of variable length, and the vectors may be represented as floating-point values rather than zeros. The terms depicted by the graph 600 depict similar words spatially close to each other and unrelated words father apart. In one embodiment, the textual similarity of the terms may be measured using cosine similarity, is a technique used to measure the cosine of the angle between two non-zero vectors and incorporates product space orientation. Vectors that are aligned in the same orientation will have a relatively higher similarity measurement (e.g., one); whereas vectors that perpendicularly align, will have a relatively lower similarity measurement (e.g., zero). As it is difficult to represent variable length vectors having multiple dimensions, the graph 600 depicts vectors having just two dimensions. In other embodiments, a Euclidean distance technique, a hamming distance technique, or a Jaccard index may be used to evaluate similarity.

FIG. 7 depicts an example implementation of a decoder-only transformer model 700 used by an implementation of the electronic file management system, in accordance with an embodiment of the present invention. Neural networks that utilize transformer models, such as the neural networks used by the systems and methods described herein, recognize patterns between the input features and the expected output by minimizing the error between the predicted outcome and the actual output. Transformer models incorporate deep learning architecture that relies on a parallel multi-head attention mechanism that incorporates parallelized processing of input text sequences. The transformer models split input text from the document data of documents similar to the query vector into n-grams encoded as tokens, and each token may then be converted, using a word-embedding table, into a vector. Each token is contextualized at each layer of the neural network within the scope of the context window with other (unmasked) tokens. This process allows the signal for key tokens to be amplified and less important tokens to be diminished.

With respect to the transformer model 700, input text, or prompt, from the document data of documents similar to the query vector is mapped to dense vectors as part of the input embedding process. Positional encoding is used to provide the transformer model 700 with additional information about the order and position of words in sentences of the documents. The positional encoding process may add a fixed-length vector to the word embedding of each word in a sentence that encodes information about the word's position in the sentence. The subsequent dropout is applied to the sums of the input embeddings and the positional encodings, and various nodes are nullified or excluded based on probabilities. The transformer block layer 1 takes a transformer block input and incorporates layer normalization to standardize the transformer block input across a mini-batch for each layer by calculating the mean and standard deviation independently over the last certain number of dimensions, which can be derived by the token embedding size. The normalization process ensures that the feature values within each token possess a mean of 0 and a standard deviation of 1. The linear layer connects every input neuron to every output neuron and performs a linear transformation by mapping input vectors to output vectors through a linear function. As depicted, this may provide a multi-headed functionality that splits the input text into multiple parts. Matrix multiplication (Matmul) is used to produce a matrix that may be masked and then normalized through SoftMax to convert vectors to a probability distribution. A dropout is applied to the probability distribution and there is another round of matrix multiplication before performing another linear transformation and another dropout. The decoder block may also incorporate an activation function such as Gaussian error linear units (GELU) activation in the decoder block that weighs inputs by their percentile. The neural network may incorporate several decoder transformation blocks before output vectors are finally normalized, mapped through a linear function and converted to a final probability distribution in order to generate a textual response to the query. The final output depends on the goal of the model. For GPT models, the output is a probability distribution of the next token/word that comes after the prompt. It outputs one prediction for the complete input and the output may be a classification, a next word, etc. In some embodiments, the semantic vector analysis module and the neural network may both incorporate a GPT model.

FIG. 8A depicts an example graphical user interface 800 that includes interactive elements used to operate an implementation of the electronic file management system, in accordance with an embodiment of the present invention. A custom prompt 805 is uniquely designed to tune the neural network (e.g., the GPT engine) so that a question is answered in the precise manner that is desired. For instance, the prompt field 805 is used to provide settings and configurations that direct the neural network on how creative to be in answering the question. The prompt input into the prompt field 805 is instrumental in generating the desired answer and to avoid using sources outside of the relevant documents or generating unsourced answers. In some embodiments, a pre-tuned setting that is recommended for the search may be provided as a default setting, and the user interface 800 may also be configured to allow respective users to modify the tuning settings away from the default setting. Thus, the prompt field 805 may be editable by the user in order to modify the default setting.

The user interface 800 may include an investigator notebook 810 based on history of question-answer events. In some embodiments, users may interrogate the corpus of documents with different lines of questioning, also referred to as arcs, so having the investigator notebook 810 allows users to easily access their query history. The investigator notebook 810 also displays an actionable control that, once selected, shows the language of the prompt input to the prompt field 805 that was used to perform the query. A response box 815 is depicted that displays the textual response to the question that is asked. The question box 820 allows the user to input a textual question and then the user may select the run input 830 in order for the system to generate the textual response in the response box 815.

A categorization input 825 is also depicted and enables the user to define categories for the question-response pair, which will be described in more detail in reference to FIG. 10. In general, the categorization input 825 allows the user to add remarks and categorize the question-answer pair so that the user can keep track of their thoughts and findings as the user performs the search.

The user interface 800 also includes a reset session input 835 that allows the user to reset their current search session. The investigator notebook 810 includes a magnifying glass icon 840 that turns selected text in the response into a Boolean searched phrase through the software program, thereby enabling a key concept to be researched further through an additional document search. A user may highlight a specific term found in the answer of the response box 815 and select the magnifying glass icon 840, which acts as a one-click shortcut to provide a user with the capability to find all documents that reference the highlighted term from the answer. The search performed using the magnifying glass icon 840 is an exact phrase search within the software program. In contrast, selection of a magic wand icon 845 creates a new GPT query of the highlighted term. When the user selects the magic wand icon 845, a new question is automatically constructed in the question box 820 to query the highlighted term: “What is [highlighted term]?” and the user may then select the run input 830 to perform the query with the automatically constructed question.

The classification icon 850 allows the user to classify a question-response that is pertinent to a different investigative arc than the current investigative arc, so selection of the classification icon 850 allows the user to add other classifications to the question-answer pair. The favorite icon 855 enables the user to pin a specific question-response pair so that it can be reviewed at a later time. The favorite icon 855 also allows the user to add a remark and a classification for future reference. The delete icon 860 is included so that if a user is trying out different questions and a question was not properly phrased or has a double meaning then the question-answer pairing can be removed from the history so that it does not unnecessarily clutter the findings. A report icon 870 enables the user to report a bad or inaccurate answer to the entity that provides the software system. The entity can harvest the responses that are marked as “bad,” investigate reasons for the “bad” response, and modify and tune system prompts or settings for future users. The document link 865 allows the user to access the subset of documents that were used by the semantic vector analysis module and the neural network to formulate the response. A drop-down input 875 enables a user to provide various inputs such as investigation prompt instructions through the question box 820.

FIG. 8B depicts an example graphical user interface 880 that includes a prompt field 884, similar to prompt field 805 of FIG. 8A, for capturing user inputs. The user inputs can include relevant background material or case context. The prompt field 884 allows the user to provide inputs of relevant background information to help the assist the generative AI engine on how to interpret certain prompts and questions. The user interface 880 may also include a section for specifying a project ID 881, a project name 882, and the name of the prompt 883.

FIGS. 8C and 8D depict portions of an example graphical user interface 885, 890 that include logical sequencing inputs, in accordance with an embodiment of the present invention. The logical sequencing inputs creates several binary questions to reduce the population of documents being searched in order to make a final determination on which documents are relevant. Advantageously, this binary question sequencing conserves computing resources by conserving the information being searched through the large language models by reducing the number of words that are being searched. The processes facilitating conservation of computing resources is further described in detail below, but these processes are maximized using topic-level questions as the high-level question followed by response-level sub-questions as part of a sequencing model. In a non-limiting example, Question 1 may be used in eDiscovery to determine whether the document shows evidence of a request from Company A to Company B. Additional sub-questions may further filter the quantity of documents to be searched. For instance, Question 1.1 asks if the document request discusses subject A, Question 1.2 discusses subject B, Question 1.3 discusses subject C. Within each sub-question, there may be further refinement using subtopics within each sub-question. For example, Question 1.1 may be further refined using Question 1.1.1 to search for topic X, Question 1.1.2 to search for topic Y, and Question 1.1.3 to search for topic Z. As depicted in FIGS. 8C, the graphical user interface 885 allows a user to add sub-questions to Question 1 by selecting the “Add Sub-Question” control input 886. Under each sub-question (i.e., Question 1.1, Question 1.2, Question 1.3), a user may further add additional sub-questions by selecting the nested “Add Sub-Question” control input 887 under a respective sub-question. If a user decides a sub-question is no longer needed, they can remove the sub-question by selecting the “trash” icon. FIG. 8D is a continuation of the sequence for Question 2 and Question 3 with additional sub-questions depicted under each question. A “Add Question” control input 891 is depicted for adding a high-level question if the user desires to add more questions than Question 1, Question 2, and Question 3.

The question sequence process depicted by FIGS. 8C and 8D is distinct from large format text input fields in which a user would enter various relevant criteria and expansive question prompts that are fed into the AI engine. The question sequence process provides several advantages over the large format text input fields that may be used to conduct a query to identify relevant documents. The question provided in the large format text input fields may be verbose with complex instructions that may not be as accurate in identifying the relevant documents. Logical question sequencing also saves graphics processing unit (GPU) computing resources pushing the questions most likely to determine relevance as a higher-level question can limit the amount of searching that needs to be performed for the sub-questions. Applicant's testing determined that question sequencing reduced the total machine compute time by about 80% as compared to conventional systems using large format text input fields.

During auditing, the sub-questions also facilitate pinpointing the questions that are generating false positives and overbroad results. By identifying the precise question causing the false positives, the question can be rephrased and retested so that the output more accurately aligns with the actual relevance. Using conventional systems with large format text input fields, it is time consuming and difficult to pinpoint the phrases, questions, or other portions of the large format text input that are contributing to false positive results. Using streamlined inputs and sub-questions improves recall and precision, where recall represents true positives that the software correctly identifies as true and precision represents the percentage of correct predictions. Applicant's testing showed that conventional systems do not achieve recall about 80% or precision about 60%, but using the question sequencing process can achieve recall about 90% and precision above 80%.

The efficiency of question sequencing can be illustrated with the following simplified examples where the question is phrased: “Is subject A related to condition B, or condition C, or condition D, or condition E?” In that case, all documents are searched for B, C, D, and E. In contrast, the process for setting up the logical question sequence is to logically group together questions based on similarity and identify the most prevalent question first in order to deconstruct the search criteria. If a document is identified as being relevant, the process stops, and the document is not searched in further questions or sub-questions. Continuing with the forgoing example, assume condition E is most prevalent. The system can first search based on the input “Is Subject A related to Condition E?” This search would narrow the corpus of documents to be searched using subsequent sequential inputs, such as next searching “Is Subject A related to Condition A?” and then “Is Subject A related to Condition B,” and so on until each input is applied.

FIG. 9A depicts an example graphical user interface 900 that pops up when the user selects the document link 865 of FIG. 8A. The graphical user interface 900 includes elements of an implementation of the electronic file management system, in accordance with an embodiment of the present invention. The graphical user interface 900 depicts not only the subset of documents that were incorporated into the search, but a column also indicates whether specific documents were fed to artificial intelligence (AI) to generate the answer. The graphical user interface 900 depicts the top-scoring documents as determined by the cosine similarity and indicates the document file type, the document file name/subject, and the system assigns a DocID to each document. If the user selects the option to view the summary, then the summary of the contents of the document may be generated. The user also has the option to view all summaries for each of the documents listed. Selection of the eye icon allows the user to view the full document, and the documents can be selected, using the check box, and sent to a folder or other location for later access.

FIG. 9B depicts an example graphical user interface 950 that depicts an example document relevance output, in accordance with an embodiment of the present invention. The document relevance output may include a document result, a sampling of content that was deemed to meet the search criteria of one or more of the Questions, and a textual response to each question. The textual response may be accessed using a drop down arrow in order to view the generated textual response to each question and sub-question.

FIG. 10 depicts an example graphical user interface 1000 for categorizing documents using an implementation of the electronic file management system, in accordance with an embodiment of the present invention. The graphical user interface 1000 is accessible from the user interface 800 and allows the user to provide remarks about a question-answer pairing and categorize the question answer pairing, the document, etc. according to one or more labels. The labels can be selected from a predefined list or can be customized by the user.

FIGS. 11A-11B depict a block diagram of an example method 1100 used by an implementation of the electronic file management system incorporating semantic vectors, in accordance with an embodiment of the present invention. At block 1105, an indication is received via a user device of a user, where the indication is for selection of a subset of documents selected from a corpus of documents. In some embodiments, the indication does not specifically indicate which documents belong to the subset, but rather the subset of documents is derived by the system based on the indication (e.g., a textual question) provided by a user. The subset of documents is to be included in an electronic document search.

At block 1110, the subset of documents is filtered according to predefined filter rules, which results in filtered documents. At block 1115, a semantic vector analysis module is applied to text of the filtered documents to build respective floating-point vectors for each document of the filtered documents. According to one embodiment, the semantic vector analysis module includes a transformer-based language model (e.g., as a non-limiting example a GPT) that is configured to pre-train deep bidirectional representations from the unlabeled text data by jointly conditioning both left and right context in all layers of the transformer-based language model. In some embodiments, the semantic vector analysis module incorporates a model that is configured to produce contextualized word vectors by encoding (i) each word's position within the text of the filtered documents, and (ii) each word of the text of the filtered documents. In some embodiments, the semantic vector analysis module is multi-threaded which enables the semantic vector analysis module to concurrently perform textual processing on multiple documents.

In some embodiments, if the filtered documents include spreadsheets, then the documents may include multiple rows and columns of data that have associated header information. The semantic vector analysis module may then be configured to embed each row of the multiple rows individually in order to maintain context of the values that are included in the rows and columns, where the context is defined by the associated header information.

The respective floating-point vectors are stored, at block 1120, to a vector database that is configured for vectorized queries to be performed thereon. The vector database is specific to the content of the filtered documents that are included in the current electronic document search. In some embodiments, the vector database includes vector data categorized according to vector distance, where the vector distance is associated with similarity of the vector data. In some embodiments, the vector database consists only of respective floating-point vectors that are specific to the filtered documents of the electronic document search, thereby excluding documents that would be unrelated to the electronic document search.

Referring now to FIG. 11B, at block 1125, a textual query is received via the user device, and based thereon the textual query is vectorized to produce a query vector that represents search criteria of the current electronic document search. At block 1130, a search is performed on the vector database in accordance with the search criteria of the query vector. The search is used to identify similar documents, from the subset of documents, which satisfy a similarity measure, where the search compares similarities of the query vector to the respective floating-point vectors.

A ranked list of vectors that include the highest similarity scores relative to the query vector is then generated, and the ranked list identifies the similar documents. At block 1135, document data of the similar documents is processed, via a neural network, to generate a textual response to the textual query, where the textual response incorporates language derived from the subset of documents. In some embodiments, the neural network includes a decoder-only transformer model such as a GPT model. The neural network is also tuned in accordance with one or more defined rules. In some embodiments, the one or more defined rules are configurable via a control input that is configured to be displayed, via a user interface of the user device, such that the one or more defined rules are capable of being modified by a user of the user device. At block 1140, one or more control signals are transmitted to the user device to initiate displaying, via the user device, the generated textual response as well as a history of question-answer events, where the history includes the textual query and the textual response.

In some embodiments, the processor further initiates displaying, via a user interface of the user device, a textual representation of the one or more defined rules (i.e., the tuning parameters). Further, the processor may initiate displaying a list indicating the similar documents as well as the one or more documents from which information for the textual response was derived. In some embodiments, the processor may also generate, via the neural network, and initiate displaying, via the user interface, a textual summary of at least one document of either the similar documents or the one or more documents from which the information for the textual response was derived. The user interface may also depict a respective control input that is associated with each of the similar documents and also the one or more documents from which the information for the textual response was derived, where each respective control input is actionable and enables the user of the user device to perform one or more user actions on the similar documents and/or the one or more documents. The processor may also initiate displaying a free text field that is configured to enable the user to provide one or more customized inputs that are associated with a question-answer event that is selected from question-answer events displayed by the history field of the question-answer events. In some embodiments, the at least one processor may initiate displaying a control input that is configured to classify each question-answer event of the history of question-answer events.

In some embodiments, the processor is also able to derive, via the neural network, whether any documents of the subset of documents satisfy one or more privileged conditions (e.g., attorney-client privilege, confidentiality, etc.). The privileged conditions may be predefined according to one or more conditions that can be set by the user. Further, the processor may initiate displaying, via a user interface of the user device, a visual indication that is used to mark one or more privileged documents that satisfy the one or more privileged conditions.

### Relevance Determinations

The systems and methods also can facilitate an auditing process to determine the rationales for why certain answers were provided to users. This implementation can leverage the neural network to determine the relevance and responsiveness for each question-answer pairing and provide a rationale as to why a specific answer was provided. In one embodiment, a user may provide an input that indicates “a document should be considered responsive to issue “A” if it includes text related to concept “1,” and this process can be repeated for several issues, either concurrently (issue “A”, issue “B” and issue “C” are analyzed at once by the system) or serially (issue “A” is analyzed first, and then if the document is considered responsive, will be secondarily analyzed for issue “B”). The systems and methods also allow users to provide context to their question by providing a thorough explanation as to what led the user to ask the question, which helps refine the response that is generated by the neural network.

In order to perform an audit analysis of the answers that were generated, the user enters key information about each issue, including whether the text related to the concept is to be considered responsive to the issue, and the neural network will iterate through each document in the subset of documents in order to make a relevance decision and generate a free-text rationale for why the relevance decision was made by the neural network. This implementation of the system may utilize enterprise-provided prompts use to feed context to the neural network. By providing the key issues, the user may instruct the neural network to provide a responsiveness determination along with a justification for each response. The responsiveness result, along with the justification for the response, are then provided to a relational database as data values in order to provide an evaluation output that can be provided for downstream review.

Advantageously, this implementation can eliminate human auditing that would be needed in order to analyze the effectiveness of the neural network. Alternatively, the time needed to perform auditing would be accelerated as more documents can be reviewed in a shorter period of time, which results in a significant cost savings. Further, if human auditing processes are implemented, this implementation may act as a quality control check on the human auditing process. Rather than taking random samples and looking for mistakes or patterns where the human auditors did not meet certain satisfaction levels within the representative sample only, the neural network can be used to look for disagreements between a human review and the automated reviewer across the entire document population so that remediation can be more narrowly tailored to those documents where disagreements are discovered. The neural network can also be used to prioritize review of certain relevance determinations so that resources are more fully utilized.

In addition, the disclosed systems and methods reduce strain on computing system resources by improving search efficiency for determining whether a document is relevant. During document review, such as an eDiscovery process, large language models process units of information (i.e., “Tokens”) that represent words or parts of words of a given document. The document may also be searched multiple times (i.e., “Repetitions”) based on the number of textual queries included in the document review process. For example, in an eDiscovery process, a user may attempt to query a corpus of documents to identify the documents that are relevant to the subject matter being litigated. The user may provide a textual query intended to capture all documents that satisfy the requirements of “Question 1.” With prior technology the large language model would need to provide a full response for every document to indicate whether each documents meets all of the conditions for “Question 1.” Once this process was performed for every document, the system would generate a textual response providing reasoning for a determination as to why each document was deemed relevant or irrelevant. On average, each textual response generated by the large language model averages 250 Tokens. Thus, if the corpus of documents included 100,000 documents and it were to take one second to generate each textual response of 250 Tokens for each of the 100,000 documents, it would take more than 24 hours to complete the entire search of the 100,000 documents for each query. This process is exemplified by Table 1 below where each set of 250 Tokens takes 1 second to generate:

TABLE 1

| Project | | Time Per | | | Documents | | |
|---|---|---|---|---|---|---|---|
| Run “As | Generated | Response | | Responsive | to Next | Total | |
| Is” | Tokens | (seconds) | Repetitions | Documents | Question | Time | |
| Question 1 | 250 | 1 | 100,000 | 7,000 | 100,000 | 27:46:40 | |
| Question 2 | 250 | 1 | 100,000 | 1,500 | 100,000 | 27:46:40 | |
| Question 3 | 250 | 1 | 100,000 | 10,000 | 100,000 | 27:46:40 | |
| Question 4 | 250 | 1 | 100,000 | 2,500 | 100,000 | 27:46:40 | |
| Question 5 | 250 | 1 | 100,000 | 300 | 100,000 | 27:46:40 | |
| Totals | | | | 21300 | | 138:53:20 | ~5.8 |
| | | | | | | | days |

In contrast, the disclosed systems and methods for question sequencing as described above in reference to FIGS. 8C-8D replaces existing processes where the large language model provides a full response for every subject matter and every condition of every query. Rather, the system reduces the population of documents needed to make a final determination by using question sequencing through several yes/no questions. Advantageously, the number of Tokens generated in the response and the number of Repetitions is reduced through question sequences, thereby reducing strain on computing resources, by breaking up the query into several simple yes/no questions. Each textual response generated for a yes/no response is only 1 Token, which takes a fraction of a second to generate. Thus, using the prior example of taking 1 second to generate a 250 Token textual response, the amount of time it would now take to generate textual responses to each of the 100,000 documents would be 400 seconds or a little more than 6.6 minutes for each yes/no determination. Of those 100,000 documents, only a subset of documents would satisfy satisfying the yes/no requirements of “Question 1,” and then that subset of documents would be searched for additional sub-questions “Question 1.1” and “Question 1.1.1.” Then the system would only need to provide a full written response (250 Tokens) for the specific subpart of documents. For “Question 2,” not all of the 100,000 documents would need to be searched because some of those documents are already determined to be included in the results due to those documents satisfying the requirements of the sub-questions of Question 1. For example, if 7,000 were to satisfy the requirements of Question 1.1.1, then those 7,000 documents would not need to be searched to determine if they satisfy the requirements of Question 2. In eDiscovery, those documents would need to be provided regardless of whether they also met the requirements of Question 2. This process continues where the documents that satisfy the requirements of sub-questions 2.1 and 2.2 would not need to be searched for Question 3. A similar analysis applies to Question 4 and Question 5. This question sequence process provides significant savings in terms of computing time, computing resources, and computer processing efficiency. The entire question sequence process is exemplified by Table 2 shown below where the total number of documents to be reviewed is 100,000 documents and each set of 250 Tokens takes 1 second to generate:

TABLE 2

| With | | Time Per | | | Documents | | |
|---|---|---|---|---|---|---|---|
| Question | Generated | Response | | Responsive | to Next | Total | |
| Sequencing | Tokens | (seconds) | Repetitions | Documents | Question | Time | |
| Question 1 | 1 | 0.004 | 100,000 | 20,000 | 20,000 | 00:06:40 | |
| Question 1.1 | 1 | 0.004 | 20,000 | 13,000 | 13,000 | 00:01:20 | |
| Question | 250 | 1 | 13,000 | 7,000 | 93,000 | 03:36:40 | |
| 1.1.1 | | | | | | | |
| Question 2 | 1 | 0.004 | 93,000 | 5,000 | 5,000 | 00:06:12 | |
| Question 2.1 | 250 | 1 | 5,000 | 1,000 | 1,000 | 01:23:20 | |
| Question 2.2 | 250 | 1 | 1,000 | 500 | 91,500 | 00:16:40 | |
| Question 3 | 1 | 0.004 | 91,500 | 50,000 | 50,000 | 00:06:06 | |
| Question 3.1 | 250 | 1 | 50,000 | 10,000 | 81,500 | 13:53:20 | |
| Question 4 | 250 | 1 | 81,500 | 2,500 | 79,000 | 21:56:40 | |
| Question 5 | 1 | 0.004 | 79,000 | 1,000 | 1,000 | 00:05:16 | |
| Question 5.1 | 1 | 0.004 | 1,000 | 250 | 250 | 00:00:04 | |
| Question | 250 | 1 | 250 | 200 | 200 | 00:04:10 | |
| 5.1.1 | | | | | | | |
| Question | 250 | 1 | 200 | 100 | | 00:03:20 | |
| 5.1.2 | | | | | | | |
| Totals | | | | 21300 | | 38:39:48 | ~1.6 |
| | | | | | | | days |

As demonstrated by the calculations from Table 2 above, the amount of time it would take to search 100,000 documents would be greatly reduced by the question sequencing process described herein. Advantageously this reduces the strain on computing resources and increases computer processing efficiency, thereby providing an improvement to the underlying computer system itself.

The system efficiency can be enhanced by altering the input question and search sequencing. End user inputs are commonly received as large format text inputs that incorporate multiple concepts and search criteria, which is standard for conventional systems and familiar to end users. Such inputs can be converted to streamlined, sequential question inputs with preferably as many binary questions as possible. The question inputs can be categorized according to one or more levels, such as Root Level (the full document population), Topic Level, Condition Level, and Response Level. The Topic Level is the overarching topic of a question sequence, and a corresponding Topic Level question should be the first question in the sequence and designed to bring back the largest number of positive search results or “hits.” The Condition Level includes any condition that is added to the Topic Level to further refine the question and that is not the final Response-Level question. The Response Level is the final condition from which the system generates a relevance determination and can itself be at any question level, such as a Topic Level question with no condition level questions.

During a system search, if a binary Topic Level question results in a “no” answer, then the document being analyzed is marked as irrelevant and no further questions are posed. On the other hand, if the answer to the Topic Level question is a “yes,” then a Condition Level question is applied to the document under analysis. There can be multiple Condition Levels such that a “yes” answer to a first Condition Level question results in a second Condition Level question being applied to the document. The questions are applied until a final Response Level question is applied to the document under analysis. A determination that a document is relevant means that it is excluded from subsequent searches, thereby reducing the corpus of documents.

The creation of sequential questions can be illustrated with the following simplified example where the large format text input from an end user is as follows: “Does a document show evidence of a request from Company A to Company B to discuss the employment confirmation letters or an employment agreement standard template where the request was made after June 3rd?” Prior to searching a corpus of documents, the large format text input is converted to a question sequence such as: (i) Topic Level-Does the document show evidence of a request from Company A to Company B?; (ii) First Condition Level (note that a “yes” response may skip to the Response Level question)—Is the document a request to discuss employment confirmation letters?; (iii) Second Condition Level—Is the document a request to discuss an employment agreement standard template?; and (iv) Response Level—Did the request occur after June 3rd? Applying the structured question sequence will result in improved performance over use of the large format text input.

Preferably, questions are sequenced such that the questions likely to yield a larger number of positive results are applied first. The questions should also be generated in a manner that preserves Boolean and “if-then” relationships in the original large format text input, such as applying two Condition Level questions to determine if a request relates to “an employment confirmation letter” OR an “employment agreement standard template,” as in the example above. The questions can also be formatted to remove jargon or ambiguous phrases from the initial end user input.

FIG. 12 is a block diagram of an example method 1200 used by an implementation of the electronic file management system, in accordance with an embodiment of the present invention. In particular, a computing environment may be configured to perform the method using at least one processor that receives, at block 1205 and via a user device of a user, one or more textual inputs indicating whether one or more documents identified is responsive to a document query. At block 1210, the processor receives, via a user device of a user, a selection of a subset of documents from a corpus of documents, the subset of documents to be analyzed in response to the one or more textual inputs. At block 1215, the processor iteratively processes, via a neural network, the subset of documents to determine a rationale for why each respective document of the subset of documents received a specific relevance score in response to the document query, wherein the neural network is tuned in accordance with one or more defined rules.

In addition, a textual response of the determined rationale is generated at block 1220, where the textual response including a justification for the specific relevance score, and at block 1225, the textual response is stored to a relational database (e.g., such as a structured query language database according to a non-limiting example).

In some embodiments, the processor is configured to identify related documents from the subset of documents, where the related documents are identified based on a common attribute between the related documents. Further, the related documents may be analyzed as a single document unit that includes all of the related documents such that the generated response applies to a single document unit. For example, there are certain types of documents that may be evaluated at a family level, such as a parent email with associated “children” attachments in an associated email chain. The system may be programed to recognize a “family” attribute with each document that is associated at the family level so that the text of all documents within the “family” (e.g., the parent email as well as the attachment “children”) are fed to the neural network as a single document unit. The responsiveness determination that is generated as part of the textual response may cascade to all members of the family unit, and this may be indicated as a unit in the relational database.

In some embodiments, batching a parallel threading may be used to distribute processing to provisioned servers across multiple data centers. In particular, the computing environment may include a plurality of network servers that are each configured to distribute network traffic in accordance with various load-balancing rules. The plurality of network servers may be configured to provide the parallel threading and batching processing of a plurality of textual responses that are stored to the relational database, where the plurality of textual responses includes the stored textual response. In some embodiments, a check may also be performed on the privilege determinations. For instance, the processor may be configured to analyze why at least one of the one or more documents was assigned a privileged condition and the neural network can generate a privileged justification for why the one or more documents was assigned a privileged condition. The privileged justification can also be included in the textual response. Advantageously, the privileged determination can be used to modify the tuning parameters in order to ensure that future searches are performed more accurately.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®,” “Windows®,” “macOS®,” “iOS®,” “Android®,” and the like may be subject to trademark rights in various jurisdictions throughout the world and are used here only in reference to the products or services properly denominated by the marks to the extent that such trademark rights may exist.

What is claimed is:

1. An electronic file management system incorporating semantic vectors, the system comprising:
at least one processor;
a communication interface communicatively coupled to the at least one processor; and
a memory device storing executable code that, when executed, causes the at least one processor to:
receive, via a user device of a user, an indication for selection of a subset of documents from a corpus of documents, the subset of documents to be included in an electronic document search;
filter the subset of documents according to predefined filter rules resulting in filtered documents;
apply a semantic vector analysis module to text of the filtered documents to build respective floating point vectors for each document of the filtered documents;
store the respective floating point vectors to a vector database configured for one or more vectorized queries to be performed thereon, wherein the vector database is specific to the filtered documents of the electronic document search;
receive, via the user device, a textual query and based thereon vectorize the textual query to produce a query vector that represents search criteria;
search, in accordance with the search criteria of the query vector, the vector database to identify similar documents from the subset of documents that satisfy a similarity measure, the searching comparing similarities of the query vector to the respective floating point vectors, and generate a ranked list of vectors comprising highest similarity scores relative to the query vector, the ranked list identifying the similar documents;
process, via a neural network, document data of the similar documents to generate a textual response to the textual query, the textual response incorporating language derived from the subset of documents, wherein the neural network is tuned in accordance with one or more defined rules; and
transmit one or more control signals to the user device to initiate displaying, via the user device, the generated textual response and a history of question answer events, the history including the textual query and the textual response.

2. The system of claim 1, wherein the semantic vector analysis module comprises a transformer-based language model configured to pre-train deep bidirectional representations from the unlabeled text data by jointly conditioning on both left and right context in all layers of the transformer-based language model.

3. The system of claim 1, wherein the semantic vector analysis module incorporates a model configured to produce contextualized word vectors by encoding (i) each word's position within the text of the filtered documents, and (ii) each word of the text of the filtered documents.

4. The system of claim 1, wherein the vector database comprises vector data categorized according to vector distance, wherein the vector distance is associated with similarity of the vector data.

5. The system of claim 1, wherein the semantic vector analysis module is multi-threaded such that the semantic vector analysis module is configured to concurrently perform textual processing on multiple documents.

6. The system of claim 1, wherein the filtered documents comprise datasets that include multiple rows and columns of data having associated header information, and the semantic vector analysis module is configured to embed each row of the multiple rows individually to maintain context of values included in the rows and columns as defined by the associated header information.

7. The system of claim 1, wherein the vector database consists only of respective floating point vectors specific to the filtered documents of the electronic document search, thereby excluding documents unrelated to the electronic document search.

8. The system of claim 1, wherein the executable code, when executed, further causes the at least one processor to initiate displaying, via a user interface of the user device:
textual representation of the one or more defined rules; and
a list indicating the similar documents and as well as one or more documents from which information for the textual response was derived.

9. The system of claim 8, wherein the executable code, when executed, further causes the at least one processor to generate, via the neural network, and initiates displaying, via the user interface, a textual summary of at least one document of either the similar documents or the one or more documents from which the information for the textual response was derived.

10. The system of claim 8, wherein a respective control input is associated with each of the similar documents and the one or more documents from which the information for the textual response was derived, wherein each respective control input is actionable thereby enabling a user of the user device to perform one or more user actions thereon.

11. The system of claim 8, wherein the executable code, when executed, further causes the at least one processor to initiate displaying a free text field configured to enable a user to provide one or more customized inputs associated with a question answer event of the history of question answer events.

12. The system of claim 8, wherein the executable code, when executed, further causes the at least one processor to initiate displaying a control input configured to classify each question answer event of the history of question answer events.

13. The system of claim 1, wherein the one or more defined rules are configurable via a control input configured to be displayed, via a user interface of the user device, such that the one or more defined rules are capable of being modified by a user of the user device.

14. The system of claim 1, wherein the neural network comprises a decoder-only transformer model.

15. The system of claim 1, wherein the executable code, when executed, further causes the at least one processor to:
derive, via the neural network, whether any documents of the subset of documents satisfy one or more privileged conditions, the one or more privileged conditions being predefined according to one or more conditions; and
initiate displaying, via a user interface of the user device, a visual indication marking one or more privileged documents that satisfy the one or more privileged conditions.

16. A computing environment, comprising:
at least one processor;
a communication interface communicatively coupled to the at least one processor; and
a memory device storing executable code that, when executed, causes the at least one processor to:
receive, via a user device of a user, one or more textual inputs indicating whether one or more documents identified in response to a document query is responsive to the document query;
receive, via a user device of a user, a selection of a subset of documents from a corpus of documents, the subset of documents to be analyzed in response to the one or more textual inputs;
iteratively process, via a neural network, the subset of documents to determine a rationale for why each respective document of the subset of documents received a specific relevance score in response to the document query, wherein the neural network is tuned in accordance with one or more defined rules;
generate a textual response of the determined rationale, wherein the textual response including a justification for the specific relevance score; and
store the textual response to a relational database.

17. The computing environment of claim 16, wherein the executable code, when executed, further causes the at least one processor to identify related documents from the subset of documents, the related documents being identified based on a common attribute between the related documents, and the related documents being analyzed as a single document unit that comprises the related documents such that the generated textual response applies to the single document unit.

18. The computing environment of claim 16, further comprising a plurality of network servers each configured to distribute network traffic in accordance with load balancing rules, the plurality of network servers configured to provide parallel threading and batch processing of a plurality of textual responses stored to the relational database, the plurality of textual responses comprising the stored textual response.

19. The computing environment of claim 16, wherein the executable code, when executed, further causes the at least one processor to analyze why at least one of the one or more documents was assigned a privileged condition and include a privileged justification in the textual response.

20. A computer-implemented method, comprising:
receiving, via a user device of a user, an indication for selection of a subset of documents from a corpus of documents, the subset of documents to be included in an electronic document search;
filtering the subset of documents according to predefined filter rules resulting in filtered documents;
applying a semantic vector analysis module to text of the filtered documents to build respective floating point vectors for each document of the filtered documents;
storing the respective floating point vectors to a vector database configured for one or more vectorized queries to be performed thereon, wherein the vector database is specific to the filtered documents of the electronic document search;
receiving, via the user device, a textual query and based thereon vectorize the textual query to produce a query vector that represents search criteria;
searching, in accordance with the search criteria of the query vector, the vector database to identify similar documents from the subset of documents that satisfy a similarity measure, the searching comparing similarities of the query vector to the respective floating point vectors, and generate a ranked list of vectors comprising highest similarity scores relative to the query vector, the ranked list identifying the similar documents; and
processing, via a neural network, document data of the similar documents to generate a textual response to the textual query, the textual response incorporating language derived from the subset of documents, wherein the neural network is tuned in accordance with one or more defined rules.
